(19) United States
(12) Patent Application Publication
(10) Pub. No.: US 2009/0047921 A1
(43) Pub. Date: Feb. 19, 2009

(54) IMAGE SUPPRESSION RECEIVER

(75) Inventor: Joji Hayashi, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Osaka (JP)

(21) Appl. No.: 12/092,719

(22) PCT Filed: Nov. 1, 2006
(86) PCT No.: PCT/JP2006/321902

§ 371 Date: May 6, 2008

(30) Foreign Application Priority Data
Nov. 7, 2005 (JP) 2005-322666

(51) Int. Cl. G06K 9/40; H04B 1/10

(52) U.S. Cl. 455/308; 382/264

(57) ABSTRACT

In an image suppression receiver which is employed in such as a heterodyne receiver, the inter-signal errors between the I signal and the Q signal becomes the noise of the image signal frequency components, and thereby the communication quality is deteriorated. In such a wireless communication device, a high performance image suppression circuit is realized.

There are provided two image suppression circuits 6-1, 6-2, and in the one hand image suppression circuit 6-1, the I signal and the Q signal are replaced and the desired wave signal is recognized as an image signal and is suppressed, and on the other image suppression receiver 6-2, it is recognized as a desired wave signal and is made pass through without occurring losses, and the phases and the amplitudes of the I signal and the Q signal are adjusted by the IQ signal adjustment circuit so that the ratio between the outputs of the respective image suppression circuits 6-1, 6-2 become the maximum. Thus, a high performance image suppression receiver can be realized.

### TECHNICAL FIELD

The present invention relates to an image suppression receiver which is a receiver in a wireless communication, and more particularly, to enhancing the performance of an image suppression receiver that is employed in such as a super-heterodyne receiver, and relates to a method of correcting the inter-signal error between the I signal and the Q signal.

### BACKGROUND ART

An image suppression receiver 100 that is employed in a general heterodyne receiver is shown in FIG. 7. (For example, Non-Patent Document 1, page 153, FIG. 5.25 is referred. In the circuit of FIG. 7, an LNA2, an ADC9, and a digital signal processing circuit 10 are added to the circuit of the document.)

In FIG. 7, numeral 2 denotes a low noise amplifier (LNA), numerals 3-1, 3-2 denote an I multiplier and a Q multiplier, respectively, numeral 4 denotes a PLL, numeral 5-1, 5-2 denote LPF, respectively, and numeral 6 denotes an image suppression circuit, numeral 8 denotes an adder, numeral 9 denotes an AD converter, and numeral 10 denotes a digital signal processing circuit, respectively.

Next, a brief operation will be described.

The received RF signal is amplified by the LNA 2 as a low noise amplifier. The RF signal that is amplified by the LNA 2 is branched into two paths, and they are multiplied by the multiplier 3-1, 3-2 with LOI signal and LOQ signal which are both generated by the PLL 4, respectively, thereby to produce I signal and Q signal, which are IF signals, respectively. Unnecessary signals in the I signal and Q signal are removed by LPF 5-1 and 5-2, respectively. The I signal and Q signal from which unnecessary signals are removed by LPF 5-1 and 5-2, respectively, are inputted into the image suppression circuit 6. The image suppression circuit 6 is constituted by a phase shifter 7 and an adder circuit 8. The I signal which is subjected to filtering by the LPF 5-1 is shifted by π/2 by the phase shifter 7, and is subjected to addition with the Q signal which has passed through the LPF 5-2 by the adder circuit 8. The output of the adder circuit 8 is converted into a digital signal from an analog signal by the ADC 9. The signal converted into the digital signal is subjected to a digital signal processing by the digital signal processing circuit 10.

Here, the frequency of the RF signal is, for example, 1 GHZ, the frequency of the LOI signal and the LOQ signal are 999 MHz, and the frequency of the IF signal is 1 MHz. While the frequency of the LOI signal and the LOQ signal are the same, the phases thereof are shifted by deviated π/2 from each other. The cutoff frequency of the filter is set at 1.5 MHz, and the signal of 1 MHz passes the filter without losses.

Next, the operation will be described in detail.

Generally, there are present a desired wave and an image wave mixed. The desired wave is a signal of a frequency that is desired to be received. The image wave is a signal that is opposite to the desired wave with putting between the LO signal. In this case, the frequency of the image wave is 998 MHz.

The image signal frequency and the desired wave frequency are multiplied with the LO signal by the multiplier 3-1 and 3-2, respectively, and they become the same frequency after being subjected to filtering by the LPF 5-1 and 5-2, respectively. However, the phase relation between the I signal and the Q signal of the image frequency is different from that of the desired wave. As shown in FIG. 8, while the signal amplitudes of the I signal and the Q signal of the image frequency coincide with each other, the phase of the I signal is delayed by π/2. In the case of the desired wave, the reverse to it does apply, and the phase of the Q signal is delayed by π/2. In the case of the image signal, it is further delayed by π/2 by the phase shifter 7 of the image suppression circuit 6, thereby resulting in a delay by π of the I signal. When two signals are shifted by in π in their phases having the same amplitudes, the amplitude of the synthesized signal becomes zero. On the contrary, the desired wave signal would have a twice signal amplitude when having passed through the image suppression circuit 6. In this way, the image signal is removed by the image suppression circuit 6, and thereby only the desired wave would appear in the output of the image suppression circuit 6.

The transmission characteristics of the image suppression circuit 6 is shown in FIG. 9. As shown in FIG. 9, while the desired wave signal can pass through without losses, the image frequency is attenuated. In this way, the image suppression receiver 100 is constructed.

In a heterodyne receiver, such image suppression receiver is essential in a case of Low-IF system where the IF frequency is less than 1/100 of the RF frequency.

Non-Patent Document 1: Tadahiro Kuroda supervision of translation, Behzad Razavi work, “RF microelectronics”, published by Maruzen Co., Ltd.

### DISCLOSURE OF THE INVENTION

### Problems to be Solved by the Invention

In the above-described conventional image suppression receiver 100, however, there is a problem that the image suppression characteristics would deteriorate when there occur phase errors or amplitude errors between the signals of I signal and Q signal due to device variations and the like. The image suppression ratio (IRR) is approximated as in formula I (refer to Non-Patent Document 1, page 156).

IRR={(ΔA/A)²+(ΔP)²]/4 (formula 1)

Here, ΔA designates the amplitude error, A designates the signal amplitude, and ΔP designates the phase error.

FIG. 10 shows the result of having calculated the influences on the IPR by the phase errors and the amplitude errors. The image suppression becomes less than 30 dB when the phase error is 3° and the amplitude error is 0.5 dB. In as general receiver, an image suppression of above 30 dB is sought. Particularly, in a CMOS semiconductor process that has large manufacture variations, there may be cases of having further larger inter-signal errors of the I signal and the Q signal, thereby resulting in serious problems.

The present invention is directed to solving the above-described problems and has for its object to provide an image suppression receiver that can carry out an image suppression precisely by providing such a construction that, being provided with two image suppression circuits, the signal paths of the I signal and Q signal are exchanged in one of the image suppression circuits thereby to detect the desired signal as an image signal, while in the other image suppression circuit the desired signal is outputted as the desired signal, and the amplitude or the phase of the I signal and the Q signal are adjusted by the IQ signal adjustment circuit so that the ratio between the respective signal amplitudes become the maximum.

### Measures to Solve the Problems

An image suppression receiver according to the present invention is constituted such that, being provided with a path switching circuit, an IQ adjusting circuit, a first image suppression circuit, and a second image suppression circuit, the connections to the I signal and to the Q signal are reversed by the path switching circuit in the first image suppression circuit, and the inter-signal errors between the I signal and the Q signal are adjusted by the IQ signal adjusting circuit so that the difference in the output levels of the first image suppression circuit and the second image suppression circuit become the maximum.

More particularly, according to claim 1 of the present invention, there is provided an image suppression receiver comprising: a low noise amplifier which amplifies inputted RF signal with low noises; a first and a second multiplier which multiply the output of said low noise amplifier with a LOI signal which is a local signal for 1 and a LOQ signal which is a local signal for Q that has the same amplitude and by 90° shifted phase with relative to the LOI signal, which are both generated by a PLL, respectively, thereby to output an I signal and a Q signal, respectively, as IF signals; a first and a second low pass filter which take out only the low frequency components from the respective I signal and Q signal outputs of said first and said second multiplier, respectively; a path switching circuit which receives the outputs of said first and said second low pass filter and outputs either of the signals to either of its outputs with switching the signal paths of said I signal and said Q signal; an IQ signal adjusting circuit to which the outputs of said path switching circuit are inputted as they are and is operated to adjust the error between the I signal and the Q signal; a first image suppression circuit which carries out image suppression to the outputs of said IQ signal adjusting circuit; a second image suppressing circuit to which the outputs of said path switching circuit are inputted as they are and is operated to carry out an image suppression to these; a first and a second A/D conversion circuit which respectively A/D convert the outputs of the first and the second image suppression circuit; a digital signal processing circuit which carries out a digital signal processing to the outputs of the first and the second A/D conversion circuit thereby to output the digital processed signals; and said IQ signal adjusting circuit adjusts the inter-signal errors between the I signal and the Q signal so that the difference between the output levels of the first and the second image suppressing circuits becomes the maximum.

An image suppression receiver according to the present invention is constituted such that, being provided with a PLL, a path switching circuit, an IQ adjusting circuit, a first image suppression circuit, and a second image suppression circuit, the connections to the I signal and to the Q signal are reversed by the path switching circuit in the first image suppression circuit, and the inter-signal errors between the LOI signal and the LOQ signal which are LO signals of the PLL are adjusted by the IQ signal adjusting circuit so that the difference in the output levels of the first image suppression circuit and the second image suppression circuit become the maximum.

More particularly, according to claim 2 of the present invention, there is provided an image suppression receiver comprising: a low noise amplifier which amplifies inputted RF signal with low noises; a first and a second multiplier which multiply the output of said low noise amplifier with a LOI signal which is a local signal for I and a LOQ signal which is a local signal for Q that has the same amplitude and by 90° shifted phase with relative to the LOI signal, which are both generated by a PLL, respectively, thereby to output an I signal and a Q signal, respectively, as IF signals; a first and a second low pass filter which take out only the low frequency components from the respective I signal and Q signal outputs of said first and said second multiplier, respectively; a path switching circuit which receives the outputs of said first and said second low pass filter and outputs either of the signals to either of its outputs with switching the signal paths of said I signal and said Q signal; an IQ signal adjusting circuit to which the outputs of said path switching circuit are inputted as they are and is operated to adjust the error between the I signal and the Q signal; a first image suppressing circuit which carries out image suppression to the outputs of said IQ signal adjusting circuit; a second image suppressing circuit to which the outputs of said path switching circuit are inputted as they are and is operated to carry out an image suppression to these; a first and a second A/D conversion circuit which respectively A/D convert the outputs of the first and the second image suppression circuit; a digital signal processing circuit which carries out a digital signal processing to the outputs of the first and the second A/D conversion circuit thereby to output the digital processed signals; and said IQ signal adjusting circuit adjusts the inter-signal errors between the LOI signal and the LOQ signal so that the difference between the output levels of the first and the second image suppressing circuits becomes the maximum.

According to the image suppression receiver of the present invention, the IQ signal adjusting circuit may adjust the phases of the I signal and the Q signal.

According to the image suppression receiver of the present invention, the IQ signal adjusting circuit may adjust the amplitudes of the I signal and the Q signal.

According to the image suppression receiver of the present invention, the frequency of the RF signal may be above 100 MHz.

According to the image suppression receiver of the present invention, the ratio between the LO signal and the IF signal may be above 100.

According to the image suppression receiver of the present invention, the IQ signal adjusting circuit may be constituted by a resister and a capacitor, and the phases of the I signal and the Q signal are adjusted by adjusting the resistance value of the resistor.

According to the image suppression receiver of the present invention, the IQ signal adjusting circuit may be constituted by a resister and a capacitor, and the phase shift amounts of the I signal and the Q signal are adjusted by adjusting the capacitance value of the capacitor.

According to the image suppression receiver of the present invention, the IQ signal adjusting circuit may be constituted such that a first resister and a second resister are connected between an input and the ground in view of AC in series, and the connection node between the first resister and the second resister is made an output, and the resistance value of the second resister is adjusted so as to adjust the amplitudes of the I signal and the Q signal.

According to the image suppression receiver of the present invention, the image suppression circuit may be constituted by a phase shifter and an adder, the phase shifter outputs the I signal with delayed by 90° with relative to the Q signal, and the adder may output a signal that is obtained by adding the output of the phase shifter and the Q signal.

According to the image suppression receiver of the present invention, the image suppression circuit may be constituted by a complex filter.

According to the image suppression receiver of the present invention, the image suppression circuit may be realized by a CMOS process.

According to the image suppression receiver of the present invention, there may be provided further a first variable gain amplifier between the first image suppression circuit and the first AD converter.

According to the image suppression receiver of the present invention, the first variable gain amplifier may change from low gain to high gain at adjusting the I and Q signals.

According to the image suppression receiver of the present invention, the image suppression circuit may be provided with further a second variable gain amplifier between the second image suppression circuit and the second AD converter.

According to the image suppression receiver of the present invention, the first and the second variable gain amplifier may be controlled such that the signal intensity of the signals which have converted into digital by the first and the second AD converters become predetermined values, respectively.

According to the image suppression receiver of the present invention, the image suppression receiver may be further provided with a first LPF and a second LPF, the first LPF may be connected to the output of the first multiplier to output the I signal as an IF signal, and the second LPF may be connected to the output of the second multiplier to output the Q signal as an IF signal.

According to the image suppression receiver of the present invention, the second image suppression circuit may output only the I signal or the Q signal.

### EFFECTS OF THE INVENTION

According to an image suppression receiver according to the present invention, there is provided a second image suppression circuit which receives a desired wave signal as an input as it is, and a first image suppression receiver which receives the desired wave signal with replacing the paths for the I signal and the Q signal, and the inter-signal errors between the I signal and the Q signal are adjusted such that the ratio between the signal intensity of the both outputs of the two image suppression circuits become the maximum, i.e., the difference in the output levels of the both outputs become the maximum. Therefore, an image suppression receiver which is superior in its image suppression characteristics is obtained.

Further, by adjusting the phases of the I signal and the Q signal such that the ratio between the signal intensity of the both outputs of the two image suppression circuits become the maximum, i.e., the difference in the output levels of the both outputs become the maximum, it is possible to obtain an image suppression receiver which is superior in its image suppression characteristics.

Further, by adjusting the amplitudes of the LOI signal and the LOQ signal of the PLL such that the ratio between the signal intensity of the both outputs of the two image suppression circuits become the maximum, i.e., the difference in the output levels of the both outputs become the maximum, it is possible to obtain an image suppression receiver which is superior in its image suppression characteristics.

Further, by providing a variable gain amplifier in front of the AD converter, and controlling its gain thereby to adjust the phases of the I signal and the Q signal such that the ratio between the signal intensity of the both outputs of the two image suppression circuits become the maximum, i.e., the difference in the output levels of the both outputs become the maximum, it is possible to obtain an image suppression receiver which is superior in its image suppression characteristics even when the bit precision of the AD converter is low.

### BRIEF DESCRIPTION OF THE DRAWINGS

FIG. 1 is a diagram illustrating an image suppression receiver according to a first embodiment of the present invention.

FIG. 2 is a diagram illustrating an image suppression receiver according to a second embodiment of the present invention.

FIG. 3 is a diagram illustrating an image suppression receiver according to a third embodiment of the present invention.

FIG. 4 is a diagram illustrating an image suppression receiver according to a fourth embodiment of the present invention.

FIG. 5 is a diagram illustrating an image suppression receiver according to a fifth embodiment of the present invention.

FIG. 6a is a diagram illustrating an exemplary construction of a phase adjusting circuit 12 in the first embodiment of the present invention and FIG. 6b is a diagram illustrating an amplitude adjusting circuit 13 in the second embodiment of the present invention.

FIG. 7 is a diagram illustrating a conventional image suppression receiver.

FIG. 8 is a diagram illustrating a relation between the I signal and the Q signal when the image signal is inputted in the prior art example.

FIG. 9 is a diagram illustrating the frequency characteristics of the image suppression circuit in the prior art example.

FIG. 10 is a diagram illustrating the image suppression ratio (IRR) against the phase errors in the in the different amplitude errors in the conventional example.

FIG. 11 is a diagram illustrating a construction of the path switching circuit 11 in the first embodiment.

### DESCRIPTION OF REFERENCE NUMERALS

100, 101, 102, 103, 104, 105 . . . image suppression receiver
2 . . . LNA
3-1, 3-2 . . . multiplier
4 . . . PLL
5-1, 5-2 . . . LPF
6, 6-1, 6-2 . . . image suppression circuit
7 . . . phase machine
8 . . . adder machine
9, 9-1, 9-2 . . . ADC
10 . . . digital signal processing circuit
11 . . . path switching circuit
12 . . . phase adjusting circuit
13 . . . amplitude adjusting circuit
14, 14-1, 14-2 . . . variable gain amplifier

### BEST MODE TO EXECUTE THE INVENTION

Hereinafter, embodiments of the present invention will be described. In the following figures, the constitutional elements which have the same function as in the conventional technique have the same reference numerals and descriptions are omitted.

### First Embodiment

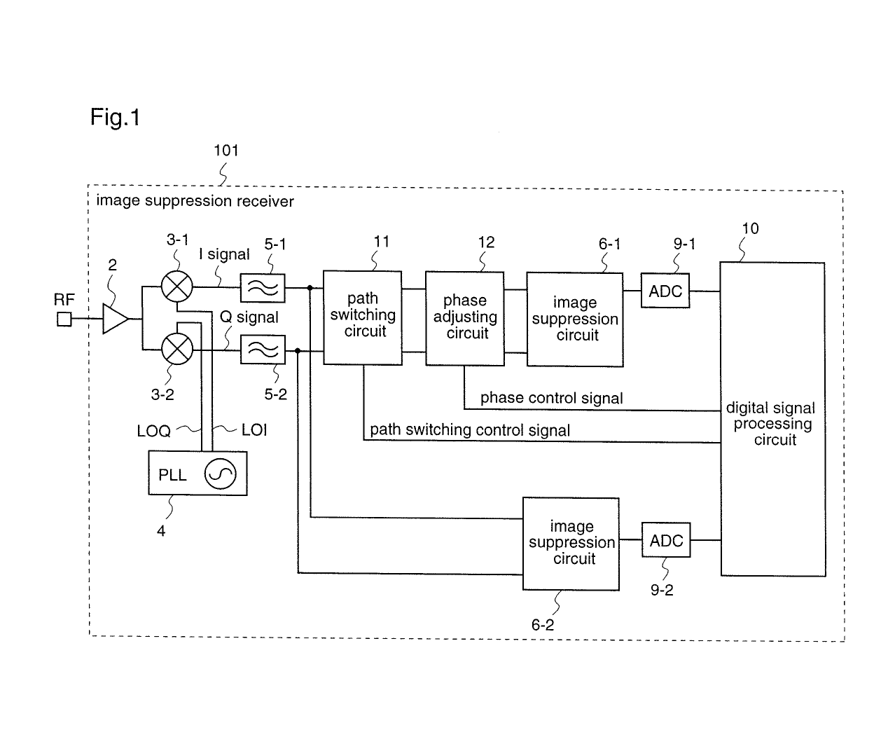

First of all, an image suppression receiver according to a first embodiment of the present invention will be described with reference to FIG. 1.

FIG. 1 is a diagram illustrating a block construction of the image suppression receiver 101 of this first embodiment.

The difference of the image suppression receiver 101 of this first embodiment from the conventional example resides in that an IQ path switching circuit 11 and the phase adjusting circuit 12 are provided in front the image suppression circuit 6-1, and further, a second image suppression circuit 6-2 which receives the outputs of the I signal and the Q signal of the first and the second multiplier 3-1, 3-2, as they are, and an ADC 9-2 which converts the analog output of the second image suppression circuit 6-2 into a digital signal.

The signal which was converted by the ADC 9-2 into a digital signal is subjected to a signal processing by the digital signal processing circuit 10.

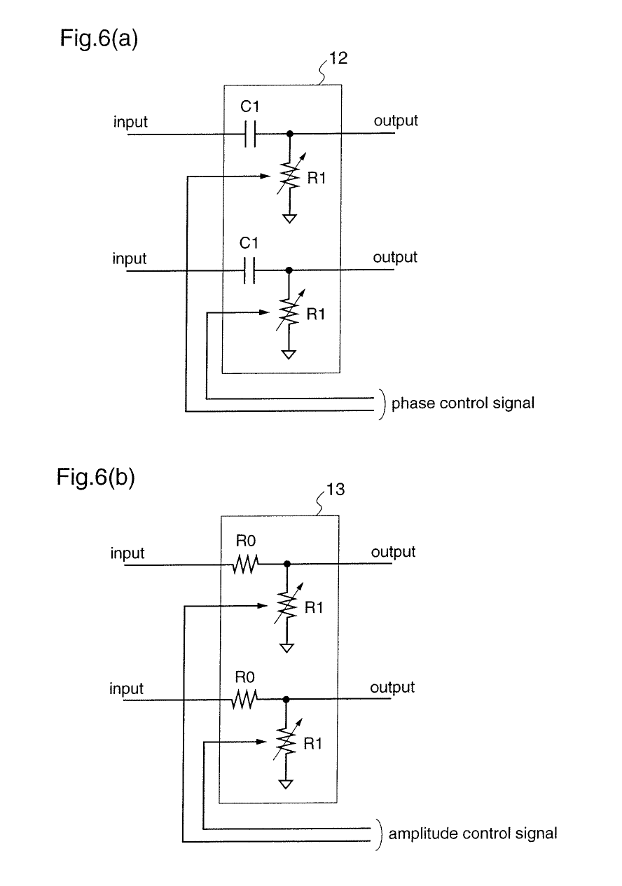

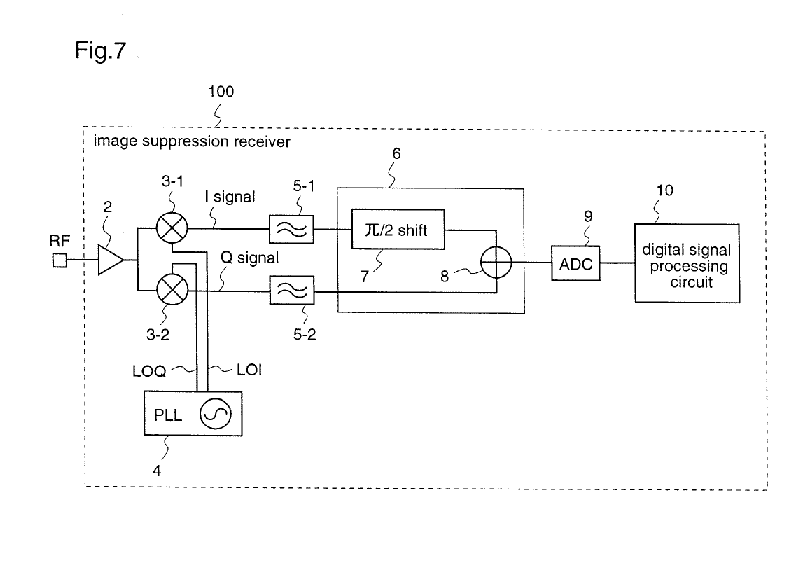

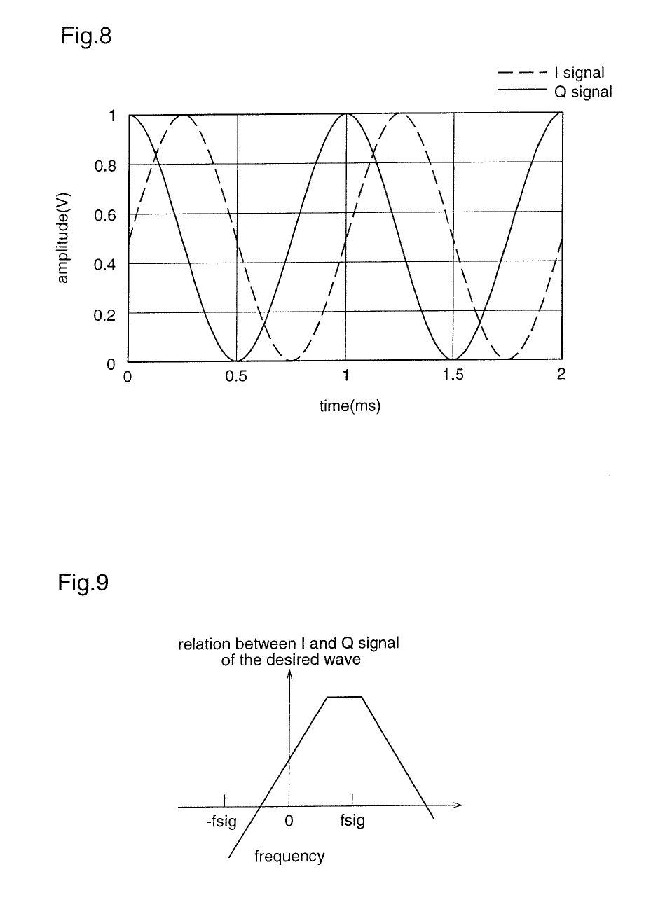

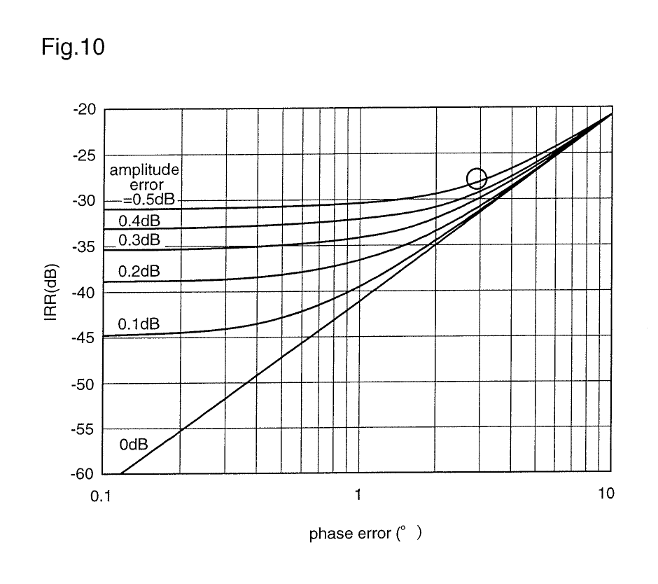

The phase adjusting circuit 12 is constituted by phase adjusting signals for I signal and for Q signal, respectively, and the respective phase adjusting circuits for the I signal and for the Q signal, are constituted by the resister R1 and the capacitance C1, respectively, as shown in FIG. 6(a), and the phase adjustment is carried out by controlling the value of the resistor R1 by a phase control signal.

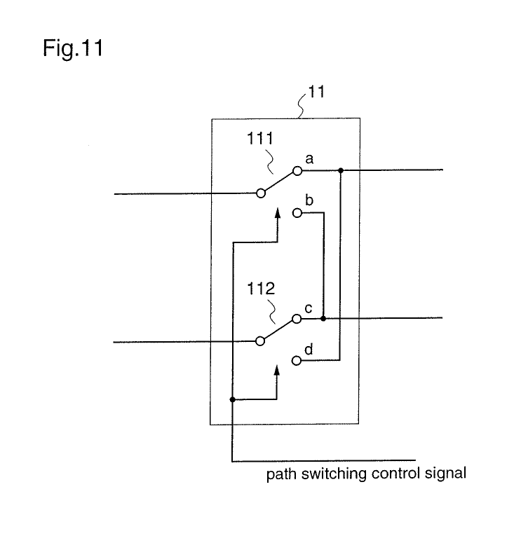

The path switching circuit 11 is controlled by a path switching signal from the digital signal processing circuit 11. FIG. 11 is a diagram illustrating an example of a construction of the path switching circuit 11. In FIG. 11, numerals 111 and 112 denote switching elements which switches the output destination of the input signal, respectively. When the switch 111 selects the terminal a, the switch element 112 selects terminal c, and when the switch 111 selects the terminal b, the switch element 112 selects the terminal d.

The IQ phase adjusting circuit 12 is controlled by a phase control signal from the digital signal processing circuit 10. The I signal and the Q signal are inputted to the image suppression circuit 6-2. The phase adjusting circuit 12 adjusts the phases of the I signal and the Q signal by 10°. Here, the frequency of the RF signal is, for example, 1 GHz, the frequency of the LOI signal and the LOQ signal are 999 MHz, and the IF signal is 1 MHz.

The operation will be described.

In the image suppression receiver 101 of the first embodiment, first of all, a desired signal is inputted as an RF signal. Then, in order to adjust the inter-signal errors between the I signal and the Q signal, the paths of the I signal and the Q signal are replaced. Then, in the first image suppression circuit 6-1, though the input signal is a desired wave signal, it is recognized as an image signal, and the signal is outputted with being suppressed.

On the other hand, from the second image suppression circuit 6-2, the input signal which is recognized as a desired signal is outputted as it is. Here, it is assumed that the input level of the RF signal is made −80 dBm and the gain of the sum of the LNA 2, the multiplier 3-1, and the multiplier 3-2 is made 40 dB. Then, the input levels of the I signal and the Q signal at the inputs of the image suppression circuit 6-1, 6-2, both become −40 dBm. When it is supposed that the phase difference between the I signal and the Q signal is 4°, and the amplitude difference is 0 dB, a signal of −60 dBm is outputted from the image suppression circuit 6-1, and a signal of −34 dBm is outputted from the image suppression circuit 6-2. These signals are converted into digital signals by the AD converters 9-1, 9-2, and the detection of the signal levels and the comparison of the signal intensity are carried out by the digital signal processing circuit 10. In this case, as the difference in the signal intensity, 26 dB is detected. Here, the adjustment is carried out by adjusting the phases of the I signal and the Q signal by the IQ phase adjusting circuit 12 according to a phase adjustment signal so that the difference in the signal intensity become the maximum. Then, when the phase adjustment is at 4°, the signal intensity ratio becomes the maximum, and the adjustment is completed.

When the adjustment is completed, the paths of the I signal and the Q signal of the IQ path switching circuit are returned to the original, and the reception of the usual signals is carried out. Then, in the image suppression circuit 6-1, the desired signal passes through as it is, and (in the second image suppression circuit 6-2,) the signal of the image frequency can be suppressed sufficiently, thereby resulting in a high precision image suppression receiver 1. At this usual operation, the image suppression circuit 6-2 and the ADC9-2 can be halted for their operations so as to save the dissipation power.

Besides, the error adjustment of the I signal and the Q signal are carried out at one time at the starting of the receiver, and by holding the correction data obtained then in a memory, and employing that value at the second time and following, the error adjustment can be abbreviated. In addition, by performing the error adjustment at shipping, storing the result in a non-volatile memory such as a flash memory, and employing the correction value which is stored in a memory at the usual use, the error adjustment can be abbreviated. In this way, by adjusting the errors between the I signal and the q signal, and enhancing the precision of the image suppression circuit, a high performance image suppression receiver 101 can be obtained.

According to the image suppression receiver 101 of the first embodiment, there are provided an IQ path switching circuit 11 and a phase adjusting circuit 12 in front the image suppression circuit 6-1, and further, a second image suppression circuit 6-2 which receive the I signal and Q signal outputs of the first and the second multiplier 3-1, 3-2, respectively, and an ADC 9-2 which converts the analog output from the second image suppression circuit 6-2 into a digital signal are provided, and in order to carry out adjustment of the inter-signal errors between the I signal and the Q signal against the desired signal, the paths of the I signal and the Q signal are replaced, thereby in the first image suppression circuit 6-1 the desired signal is recognized as an image signal thereby to carry out suppression of the signal, while in the second image suppression circuit 6-2 the input signal is outputted with being recognized as a desired signal as it is, and thereby, the phases of the I signal and the Q signal are adjusted in the IQ phase adjustment circuit 12, and thus, a high precision and a high performance image suppression receiver having superior image suppressing characteristics is obtained.

### Second Embodiment

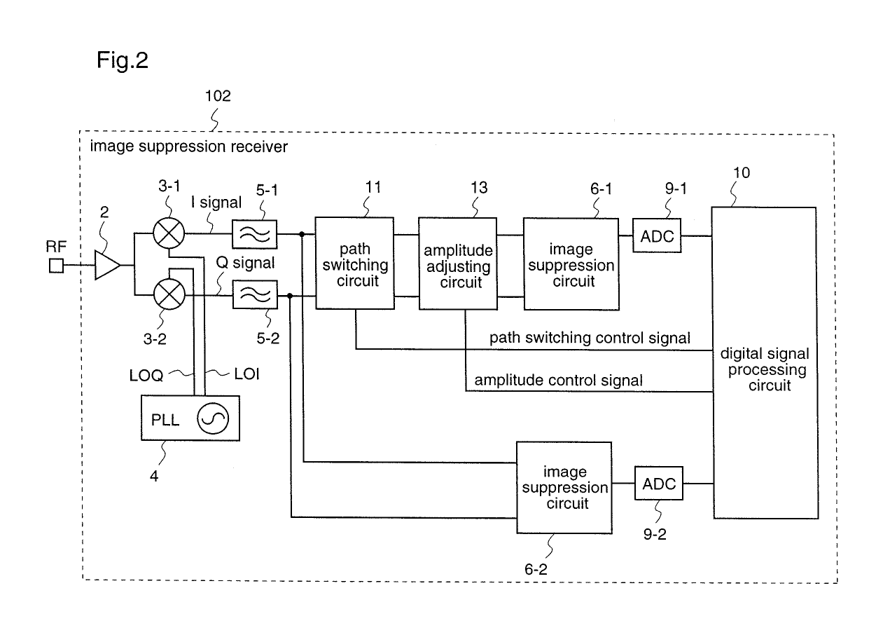

Next, an image suppression receiver according to a second embodiment of the present invention will be described with reference to FIG. 2.

The difference of this image suppression receiver 102 of the second embodiment from the image suppression receiver 101 of the first embodiment resides in that, being provided with an amplitude adjustment circuit 13 in place of the phase adjusting circuit 12 shown in FIG. 1, the amplitude of the I signal and the Q signal are adjusted with an amplitude control signal being applied to the amplitude adjusting circuit.

In the image suppression receiver 102 of this second embodiment shown in FIG. 2, the amplitude adjusting circuit 13 is constituted by amplitude adjusting circuits for I signal and for Q signal, and respective amplitude adjusting circuits for I signal and for Q signal are constituted by, for example, a resister R1 and a resister R0, respectively, as shown in FIG. 6(b), and an amplitude adjustment is carried out by controlling the value of the resister R1 by an amplitude control signal. The amplitude adjustment circuit 13 adjusts the amplitudes of the I signal and the Q signal by 1.0 dB. The image suppression receiver 1 is realized by a CMOS process on the same semiconductor substrate.

Next, the operation will be described.

A desired wave signal is inputted into the RF signal. In order to adjust the inter-signal error between the I signal and the Q signal, the paths of the I signal and the Q signal are replaced by the IQ path switching circuit 11. Then, from the image suppressing circuit 6-1, a signal which is recognized as an image signal and is suppressed though it is a desired signal is outputted.

On the other hand, from the second image suppression circuit 6-2, an input signal is recognized as a desired signal, and it is outputted as it is. Here, the input level of the RF signal is made −80 dBm, and the gain of the sum of the LNA 2, the multiplier 3-1, and the multiplier 3-2 is made 40 dB. Then, the input levels of the I signal and the Q signal at the inputs of the image suppression circuit 6-1, 6-2, both become −40 dBm. When it is supposed that the phase difference between the I signal and the Q signal is 0°, and the amplitude difference is 0.5 dB, a signal of −65 dBm is outputted from the image suppression circuit 6-1, and a signal of −34 dBm is outputted from the image suppression circuit 6-2. These signals are converted into digital signals by the AD converters 9-1, 9-2, and the detection of the signal levels and the comparison of the signal intensity are carried out by the digital signal processing circuit 10. In this case, as the difference in the signal intensity, 31 dB is detected. Here, the adjustment is carried out by adjusting the amplitudes of the I signal and the Q signal by the amplitude adjusting circuit 13 so that the difference in the signal intensity become the maximum. Then, when the amplitude adjustment is made 0.5 dB, the signal intensity ratio becomes the maximum, and the adjustment is completed.

When the adjustment is completed, the paths of the I signal and the Q signal of the IQ path switching circuit are returned to the original, and thereby the reception of the usual signals is carried out. Then, in the image suppression circuit 6-1, the desired signal passes through as it is and the signal of the image frequency can be suppressed sufficiently, thereby resulting in a high precision image suppression receiver 1. At performing this usual operation, the image suppression circuit 6-2 and the ADC9-2 can be halted for their operations so as to save the dissipation power.

Besides, the error adjustment of the I signal and the Q signal are carried out at one time at the starting of the receiver, and by holding the correction data obtained then in a memory, and employing that value at the second time and following, the error adjustment can be abbreviated. In addition, by performing the error adjustment at shipping, storing the result in a non-volatile memory such as a flash memory, and employing the correction value which is stored in a memory at the usual use, the error adjustment can be abbreviated. In this way, by adjusting the errors between the I signal and the Q signal, and enhancing the precision of the image suppression circuit, a high performance image suppression receiver can be obtained.

According to the image suppression receiver 102 of the second embodiment, there is provided an amplitude adjusting circuit 13 in place of the phase adjusting circuit 12 in the image suppression circuit 12 in the image suppression receiver 101 of the first embodiment, and in order to carry out adjustment of the inter-signal errors between the I signal and the Q signal against the desired signal, the paths of the I signal and the Q signal are replaced, thereby in the first image suppression circuit 6-1 the desired signal is recognized as an image signal thereby to carry out suppression of the signal, while in the second image suppression circuit 6-2 the input signal is outputted with being recognized as a desired signal as it is, and then, the amplitudes of the I signal and the Q signal are adjusted in the IQ phase adjustment circuit 13, and thereby, a high precision and a high performance image suppression receiver having superior image suppressing characteristics is obtained.

### Third Embodiment

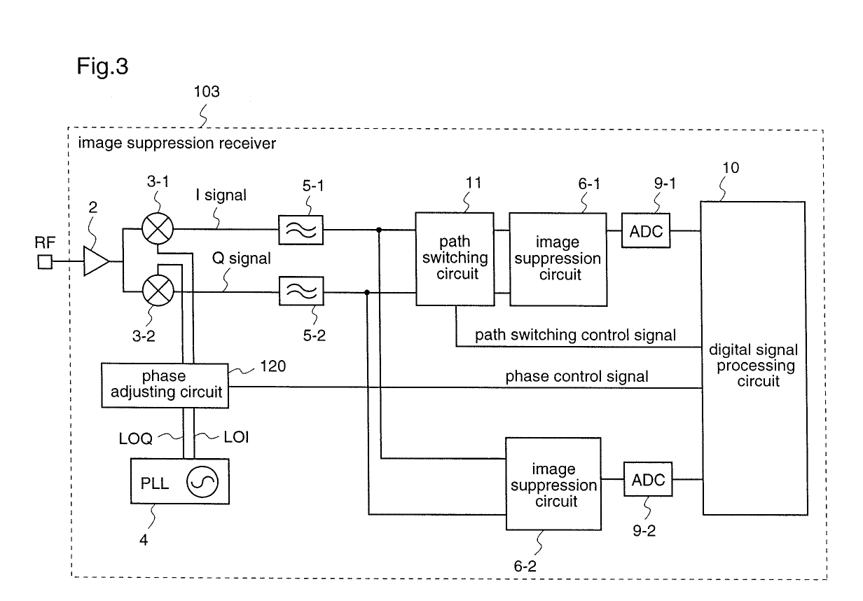

Next, an image suppression receiver according to a third embodiment of the present invention will be described reference to FIG. 3.

The difference of this image suppression receiver 103 of the third embodiment from the image suppression receiver 101 of the first embodiment resides in that, in place of the phase adjustment being carried out by using the I signal and the Q signal as IF signals as shown in FIG. 1, the adjustment of phases of the LOQ signal and the LOI signal as LO signals of the PLL 4 is carried out by the phase adjustment circuit 120 as shown in FIG. 3. Thus, by adjusting the phases of the LOQ signal and the LOI signal as LO signals of the PLL 4, the adjustment of phases of the I signal and the Q signal can be carried out, thereby it is possible to obtain a high performance image suppression receiver similarly as in the first embodiment.

According to the image suppression receiver 103 of the third embodiment, the phase adjustment is carried out such that the phases of the LOQ signal and the LOI signal as LO signals of the PLL 4 are adjusted by the phase adjustment circuit 120. Also by such a construction, the adjustment of the phases of the I signal and the Q signal can be carried out, and thereby a high precision and high performance image suppression receiver that has a superior image suppression characteristics can be obtained similarly as in the first embodiment.

### Fourth Embodiment

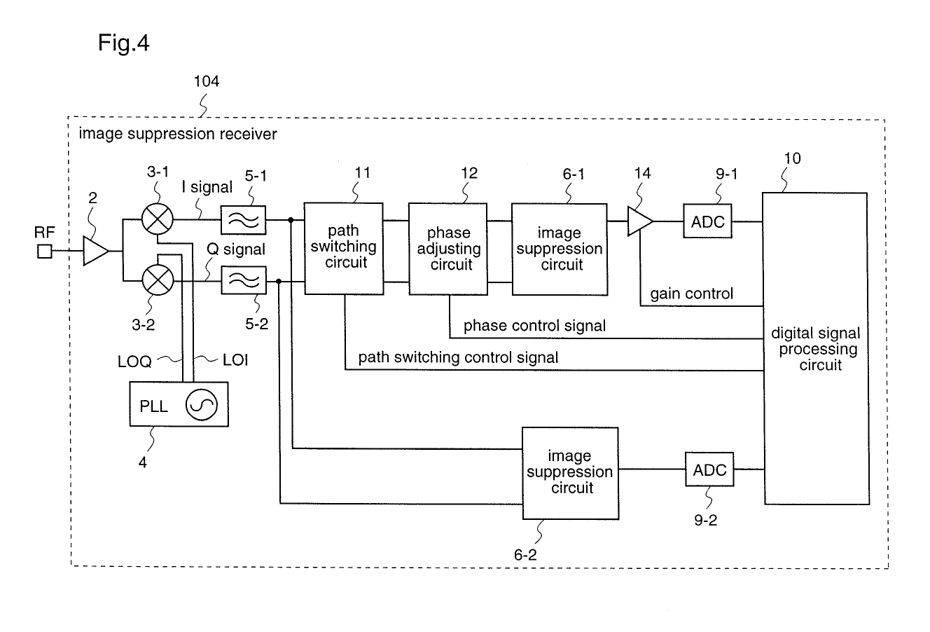

Next, an image suppression receiver according to a fourth embodiment of the present invention will be described with reference to FIG. 4.

The difference of this image suppression receiver 104 of the fourth embodiment from the image suppression receiver 101 of the first embodiment resides in that there is provided a variable gain amplifier 14 in front the ADC 9-1. This variable gain amplifier 14 is set to High gain or Low gain, by a gain control signal from the digital signal processing circuit 10.

Next, the operation will be described.

In the image suppression receiver 104 of this fourth embodiment, first of all, a desired wave signal is inputted into the RF signal. In order to adjust the inter-signal error between the I signal and the Q signal, the paths of the I signal and the Q signal are replaced by the IQ path switching circuit 11. In addition, the gain of the variable gain amplifier 14 is set to High gain.

In the image suppressing circuit 6-1, an input signal which is a desired wave signal is recognized as an image signal even though it is a desired wave signal, the signal is suppressed. Further, it passes through the variable gain amplifier 14 and is inputted to the ADC 9-1.

On the other hand, from the second image suppression circuit 6-2, an input signal is recognized as a desired wave signal, and it is outputted as it is. Here, the input level of the RF signal is made −80 dBm, the gain of the sum of the LNA 2, the multiplier 3-1, and the multiplier 3-2 is made 40 dB, and the High gain of the variable gain amplifier is supposed 20 dB and the Low gain is 0 dB. Then, the input levels of the I signal and the Q signal at the inputs of the image suppression circuit 6-1, 6-2, both become −40 dBm. When it is supposed that the phase difference between the I signal and the Q signal is 4°, and the amplitude difference is 0 dB, a signal of −40 dBm is outputted from the image suppression circuit 6-1, and a signal of −34 dBm is outputted from the image suppression circuit 6-2. These signals are converted into digital signals by the AD converters 9-1, 9-2, and the detection of the signal levels and the comparison of the signal intensity are carried out by the digital signal processing circuit 10. Then, since the signal is amplified by the variable gain amplifier 14, the dynamic range of the AD converter 9-1 can be made small with relative to the first embodiment. In this case, as the difference in the signal intensity, 6 dB is detected. Here, the adjustment of the phase is carried out by adjusting the amplitudes of the I signal and the Q signal by the IQ phase adjusting circuit 12 according to a phase adjustment signal, and the adjustment is carried out until the difference in the signal intensity becomes the maximum. Then, when the phase adjustment is 4°, the signal intensity ratio becomes the maximum, and the adjustment is completed.

When the adjustment is completed, the paths of the I signal and the Q signal of the IQ path switching circuit are returned to the original, and the gain of variable gain amplifier 14 is made Low gain, and thereby the reception of the usual signals is carried out. Thereby, the dynamic range of the ADC 9-1 can be made smaller than in the first embodiment, and it is possible to obtain a high precision image suppression receiver 104 in which the desired signal passes through as it is and the signal of the image frequency can be suppressed sufficiently.

According to the image suppression receiver 104 of the fourth embodiment, in the construction of the first embodiment, a variable gain amplifier 14 amplifying a signal is provided in front the AD converter 9-1, and this is set to a High gain or a Low gain by a gain control signal. Therefore, by adjusting the phases of the I signal and the Q signal so that the ratio between the signal intensity of the outputs of the two image suppression circuits is the maximum, an image suppressing receiver that is superior in the image suppressing characteristics can be constituted. Further, the dynamic rage of the AD converter 9-1 can be made smaller than in the first embodiment, and an image suppressing receiver which is superior in the image suppressing characteristics and has high precision and high performance can be easily obtained even if the bit precision of an AD converter is low.

### Fifth Embodiment

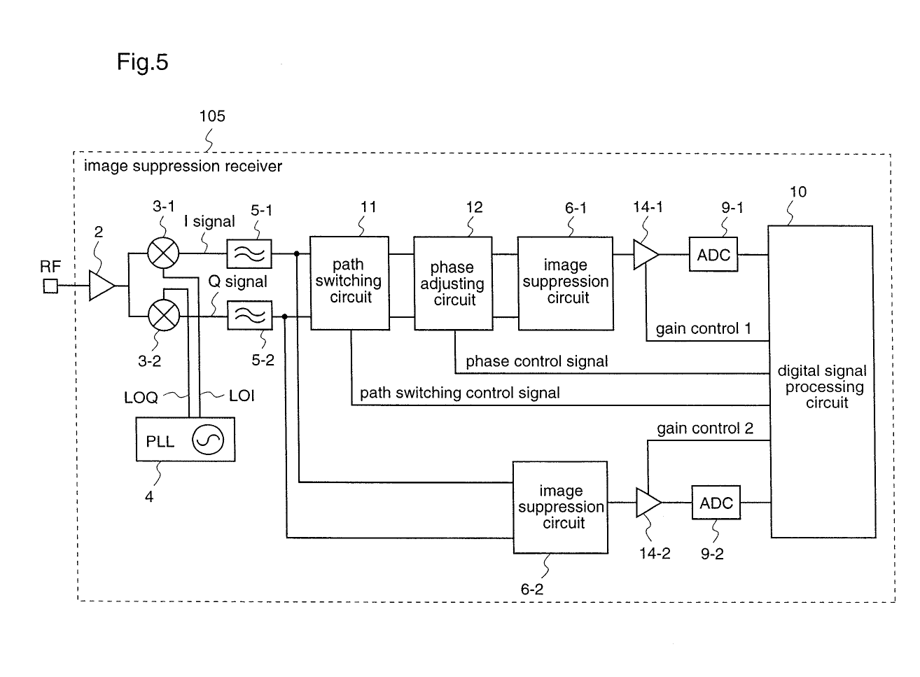

Next, an image suppression receiver according to a fifth embodiment of the present invention will be described reference to FIG. 5.

The difference of this image suppression receiver 105 of the fifth embodiment from the image suppression receiver 101 of the first embodiment resides in that there are provided variable gain amplifier 14-1, 14-2 in front the ADC 9-1, 9-2, respectively. The gains of the variable gain amplifier 14-1, 14-2 are controlled by the digital signal processing circuit 10 so that the signal levels at the inputs of the AD converter 9-1, 9-2 are the predetermined levels. Thereby, even when the signal level of the RF signal is varied, the signal levels of the variable gain amplifier 14-1, 14-2 are adjusted at constant, thereby enabling to make the bit precision of the ADC 9-1, 9-2, at low.

Next, the operation will be described.

In the image suppression receiver 105 of this fifth embodiment, first of all, a desired wave signal is inputted into the RF signal. In order to adjust the inter-signal error between the I signal and the Q signal, the paths of the I signal and the Q signal are replaced by the IQ path switching circuit 11. Then, in the first image suppression circuit 6-1, though the input signal is a desired wave signal, it is recognized as an image signal, and the signal is suppressed. Then, by the digital signal processing circuit 10, it is judges as the signal level is not reached a reference level, and the gain of the variable gain amplifier 14-1 is adjusted to be made large. Here, it is assumed that the input level of the RF signal is made −80 dBm and the gain of the sum of the LNA 2, the multiplier 3-1, and the multiplier 3-2 is made 40 dB. Then, the input levels of the I signal and the Q signal at the inputs of the image suppression circuit 6-1, 6-2, both become −40 dBm. When it is supposed that the phase difference between the I signal and the Q signal is 40, and the amplitude difference is 0 dB, a signal of −60 dBm is outputted from the image suppression circuit 6-1, and a signal of −34 dBm is outputted from the image suppression circuit 6-2. If it is supposed that the reference level of the signal level at the digital signal processing circuit 10 is −10 dBm, the gain of the variable gain amplifier 14-1 becomes 50 dB, and the gain of the variable gain amplifier 14-2 becomes 24 dB. Here, the adjustment is carried out by adjusting the phases of the I signal and the Q signal by the IQ phase adjusting circuit 12 according to a phase adjustment signal so that the difference in the signal intensity become the maximum. Then, when the phase adjustment is at 4°, the signal intensity ratio becomes the maximum, and the adjustment is completed.

When the adjustment is completed, the paths of the I signal and the Q signal of the IQ path switching circuit are returned to the original, and the reception of the usual signals is carried out. Then, in the image suppression circuit 6-1, the desired signal passes through as it is, and in the second image suppressing circuit 6-2, the signal of the image frequency can be suppressed sufficiently, thereby resulting in a high precision and high performance image suppression receiver.

According to the image suppression receiver 105 of the fifth embodiment, in the construction of the first embodiment, variable gain amplifier 14-1, 14-2 each amplifying a signal are provided in front the AD converter 9-1, 9-2, respectively, and these variable gain amplifiers 14-1, 14-2 are subjected to gain controls so that the signal levels at the inputs of the AD converter 9-1, 9-2 are the predetermined levels. Therefore, by adjusting the phases of the I signal and the Q signal so that the ratio between the signal intensity of the outputs of the two image suppression circuits is the maximum, an image suppressing receiver that is superior in the image suppressing characteristics can be constituted. Further, the bit precision of the AD converter can be made low even for variations in the signal levels of the RF signal, and thereby, an image suppressing receiver which is superior in the image suppressing characteristics and has high precision and high performance can be easily obtained.

Besides, the present invention is not limited to concrete examples such as the RF frequency and LO frequency, the IF frequency, the LNA 2 and the multiplier 3, the gain of the variable gain amplifier, and the image suppressing circuit 6 which are illustrated in the first to the fifth embodiments. The LNA2 is not required if there is no problem in the sensitivity. The image suppression circuit 6 may be any one that can suppress the image frequency components in the inputs of the I signal and Q signal. For example, the image suppression circuit 6 may be a complex filter. When the image suppression circuit is a complex filter, since the complex filter removes unnecessary signals, LPF5-1 and 5-2 are not required. Moreover, while in the embodiments the path switching circuit 11 replaces the I signal and the Q signal, when the I signal and Q signal are differential signals, respectively, either of the differential signals may be replaced for its polarity.

While in the first embodiment, the phases of the I signal and Q signal are adjusted by the phase adjustment circuit 12, an amplitude adjustment circuit 13 may be further provided so as to adjust the amplitudes of the I signal and Q signal by an amplitude control signal. Then, the amplitude adjustment may be carried out after the phase adjustment is carried out, it may be conducted reversely.

Further, while the phase adjustment circuit 12 is arranged at rear the path switching circuit 11, an amplitude adjustment circuit 13 may be in front. In addition, the phase adjustment circuit 12 and the amplitude adjustment circuit 13 may be arranged anywhere if the adjustment of the phases or amplitudes of the I signal and the Q signal can be carried out.

Further, the path switching circuit 11 may be arranged anywhere if the desired wave signal is recognized as an image signal and suppressed with the path being switched though it is a desired wave signal in the image suppressing circuit 6-1, and it is recognized as a desired wave signal in the image suppressing circuit 6-2.

In addition, while the phase adjustment circuit 12 is constituted by a resister R1 and a capacitor C1 and the resistance R1 is made variable, the capacitance C1 mat e made variable.

In addition, the construction of the concrete examples of the phase adjustment circuit 12 and the amplitude adjustment circuit 13 are not essential in the present invention and they are may be any of those constructions which can carry out control of the phase and the control of the amplitude.

In addition, in the above, examples in which the image suppressing receivers are constructed by CMOS processes, those may be realized by BiCMOS processes or Bipolar processes, with the same effects as described above.

In summary, it is sufficient if an image suppression receiver which, being provided with two image suppressing circuits, on one hand the input of the desired wave signal is recognized as an image signal is suppressed with the I signal and the Q signal being replaced, while on the other hand it is made pass through as a desired wave signal without occurring losses, and thereby the correction of the phases and amplitudes of the I signal and the Q signal are carried out so that the ratio between the output levels of the respective image suppression circuits become the maximum is constituted.

### APPLICABILITY IN INDUSTRY

The image suppression receiver according to the present invention can provide an image suppression receiver having superior image suppressing characteristics by adjusting the phases of the I signal and the Q signal so that the ratio between signal intensity between the outputs of the two image suppression circuits, and it is useful in a receiver circuit in a wireless communication.

1. An image suppression receiver comprising:
a low noise amplifier which amplifies inputted RF signal with low noises;
a first and a second multiplier which multiply the output of said low noise amplifier with a LOI signal which is a local signal for I and a LOQ signal which is a local signal for Q that has the same amplitude and by 90° shifted phase with relative to the LOI signal, which are both generated by a PLL, respectively thereby to output an I signal and a Q signal, respectively, as IF signals;
a first and a second low pass filter which take out only the low frequency components from the respective I signal and Q signal outputs of said first and said second multiplier, respectively;
a path switching circuit which receives the outputs of said first and said second low pass filter and outputs either of the signals to either of its outputs with switching the signal paths of said I signal and said Q signal;
an IQ signal adjusting circuit to which the outputs of said path switching circuit are inputted as they are and is operated to adjust the error between the I signal and the Q signal;
a first image suppressing circuit which carries out image suppression to the outputs of said IQ signal adjusting circuit;
a second image suppressing circuit to which the outputs of said path switching circuit are inputted as they are and is operated to carry out an image suppression to these;
a first and a second A/D conversion circuit which respectively A/D convert the outputs of the first and the second image suppression circuit;
a digital signal processing circuit which carries out a digital signal processing to the outputs of the first and the second A/D conversion circuit thereby to output the digital processed signals; and
said IQ signal adjusting circuit adjusts the inter-signal errors between the I signal and the Q signal so that the difference between the output levels of the first and the second image suppressing circuits becomes the maximum.

2. An image suppression receiver comprising:
a low noise amplifier which amplifies inputted RF signal with low noises;
a first and a second multiplier which multiply the output of said low noise amplifier with a LOI signal which is a local signal for I and a LOQ signal which is a local signal for Q that has the same amplitude and by 90° shifted phase with relative to the LOI signal, which are both generated by a PLL, respectively thereby to output an I signal and a Q signal, respectively, as IF signals;
a first and a second low pass filter which take out only the low frequency components from the respective I signal and Q signal outputs of said first and said second multiplier, respectively;
a path switching circuit which receives the outputs of said first and said second low pass filter and outputs either of the signals to either of its outputs with switching the signal paths of said I signal and said Q signal;
an IQ signal adjusting circuit to which the outputs of said path switching circuit are inputted as they are and is operated to adjust the error between the I signal and the Q signal;
a first image suppressing circuit which carries out image suppression to the outputs of said IQ signal adjusting circuit;
a second image suppressing circuit to which the outputs of said path switching circuit are inputted as they are and is operated to carry out an image suppression to these;
a first and a second A/D conversion circuit which respectively A/D convert the outputs of the first and the second image suppression circuit;
a digital signal processing circuit which carries out a digital signal processing to the outputs of the first and the second A/D conversion circuit thereby to output the digital processed signals; and
said IQ signal adjusting circuit adjusts the inter-signal errors between the LOI signal and the LOQ signal so that the difference between the output levels of the first and the second image suppressing circuits becomes the maximum.

3. An image suppression receiver as defined in claim 1, wherein:
said IQ signal adjusting circuit adjusts the phases of the I signal and the Q signal.

4. An image suppression receiver as defined in claim 1, wherein:
said IQ signal adjusting circuit adjusts the amplitudes of the I signal and the Q signal.

5. An image suppression receiver as defined in claim 1, wherein:
the frequency of the RF signal may be above 100 MHz.

6. An image suppression receiver as defined in claim 1, wherein:
the ratio between the LO signal and the IF signal may be above 100.

7. An image suppression receiver as defined in claim 1, wherein:
said image suppression circuit is constituted by a phase shifter and an adder,
said phase shifter outputs the I signal with delaying the phase thereof by 90°, and
said adder outputs the output of said phase shifter and the Q signal.

8. An image suppression receiver as defined in claim 1, wherein:
said image suppression circuit is constituted by a complex filter.

9. An image suppression receiver as defined in claim 3, wherein:
said IQ signal adjustment circuit is constituted by a resister and a capacitor, and the phases of the I signal and the Q signal are adjusted by adjusting the resistance value of said resister.

10. An image suppression receiver as defined in claim 3, wherein:
said IQ signal adjustment circuit is constituted by a resister and a capacitor, and the phase shift amounts of the I signal and the Q signal are adjusted by adjusting the capacitance value of said capacitor.

11. An image suppression receiver as defined in claim 4, wherein:
said IQ signal adjusting circuit may be constituted such that a first resister and a second resister are connected between an input and the ground in view of AC in series, and the connection node between the first resister and the second resister is made an output, and the resistance value of the second resister is adjusted so as to adjust the amplitudes of the I signal and the Q signal.

12. An image suppression receiver as defined in claim 1, wherein:
said receiver is realized by a CMOS process.

13. An image suppression receiver as defined in claim 1, wherein:
there is further provided a first variable gain amplifier between said first image suppression circuit and said first AD converter.

14. An image suppression receiver as defined in claim 13, wherein:
said first variable gain amplifier becomes from Low gain to High gain at adjusting the IQ signal.

15. An image suppression receiver as defined in claim 1, wherein:
there is further provided a second variable gain amplifier between said second image suppression circuit and said second AD converter.

16. An image suppression receiver as defined in claim 13, wherein:
said first and second variable gain amplifiers are controlled by said first and said second AD converters, respectively, so that the signal intensity of the signals converted by said first and said second AD converters into digital signals, respectively, become predetermined values.

17. An image suppression receiver as defined in claim 1, wherein:
there is further provided a first LPF and a second LPF,
the first LPF outputs the I signal as IF signal with being connected to the output of the first adder, and
the second LPF outputs the Q signal as IF signal with being connected to the output of the second adder.

18. An image suppression receiver as defined in claim 1, wherein:
said second image suppressing circuit outputs only either of the I signal and the Q signal.

19. An image suppression receiver as defined in claim 15, wherein:
said first and second variable gain amplifiers are controlled by said first and said second AD converters, respectively, so that the signal intensity of the signals converted by said first and said second AD converters into digital signals, respectively, become predetermined values.
